(19) United States
(12) Patent Application Publication
(10) Pub. No.: US 2026/0368924 A1
(43) Pub. Date: Nov. 19, 2026

(54) MODEL CONSTRUCTION METHOD, POSE DETERMINATION METHOD, APPARATUS, DEVICE, AND MEDIUM

(71) Applicant: Beijing Zitiao Network Technology Co., Ltd., Beijing (CN)

(72) Inventors: Gaojie LIN, Beijing (CN); Congyi WANG, Beijing (CN); Feida ZHU, Beijing (CN)

(21) Appl. No.: 19/477,476

(22) PCT Filed: Mar. 27, 2024
(86) PCT No.: PCT/CN2024/083967

§ 371 Date: Oct. 21, 2025

(30) Foreign Application Priority Data
Apr. 21, 2023 (CN) 202310440737.4

(51) Int. Cl. G06T 7/73; G06T 11/00

(52) U.S. Cl. CPC G06T 7/75; G06T 11/00; G06T 2207/20081; G06T 2207/20084

(57) ABSTRACT

Disclosed in the present disclosure are a model construction method, a pose determination method, and a device. The model construction method includes: obtaining a sample image, a pose data label corresponding to the sample image, and reference pose data corresponding to the sample image, wherein the sample image is used to describe a target part of a first object, and the pose data label is used to describe an actual pose of the target part in the sample image; extracting an image feature from the sample image by using a pose recognition model that is pre-constructed; training a first pose determination model by using the image feature, the reference pose data, and the pose data label; and determining a second pose determination model based on the pose recognition model and a trained first pose determination model.

The present application claims priority to and benefits of Chinese Patent Application No. 202310440737.4, filed on Apr. 21, 2023. The aforementioned Chinese patent application is incorporated herein by reference in its entirety as part of the present application.

### TECHNICAL FIELD

The present application relates to a model construction method and apparatus, a pose determination method and apparatus, a device, and a medium.

### BACKGROUND

In some application scenarios (e.g., hand reconstruction, foot reconstruction, and other scenarios), it is necessary to first analyze the pose of a certain part (e.g., a hand, a foot, etc.) from an image sequence, and then reconstruct that part based on the pose.

However, how to determine the pose of a certain part is a technical problem that urgently needs to be solved.

### SUMMARY

The present application provides a model construction method and apparatus, a pose determination method and apparatus, a device, and a medium, which can implement a pose determination process for a certain part.

To achieve the above objective, the present application provides the following technical solutions.

The present application provides a model construction method. The method comprises:
obtaining a sample image, a pose data label corresponding to the sample image, and reference pose data corresponding to the sample image, where the sample image is used to describe a target part of a first object, and the pose data label is used to describe an actual pose of the target part in the sample image;
extracting an image feature from the sample image by using a pose recognition model that is pre-constructed;
training a first pose determination model by using the image feature, the reference pose data, and the pose data label; and
determining a second pose determination model based on the pose recognition model and the trained first pose determination model.

In a possible implementation, the reference pose data comprises at least one of the group consisting of associated part pose data and historical reference data, the associated part pose data being used to describe an actual pose of a reference part associated with the target part in a to-be-used image, where the reference part and the target part belong to the same object, the to-be-used image is used to describe at least two parts of the first object, the at least two parts comprising the target part and the reference part, the sample image is determined based on the to-be-used image, and the historical reference data is used to describe a historical state of the target part.

In a possible implementation, the historical reference data comprises at least one of the group consisting of historical pose data, a historical pose change rate, and a historical pose change acceleration.

In a possible implementation, the reference part is a parent node of the target part.

In a possible implementation, an obtaining process for the reference pose data comprises:
matching the pose data label with at least one data frame in a motion capture database, where the data frame comprises pose data of several parts, the several parts comprising the target part; and
determining, in response to that there is a data frame in the motion capture database that matches the pose data label, the reference pose data corresponding to the sample image based on the data frame that is matched.

In a possible implementation, an obtaining process for the reference pose data comprises:
randomly selecting a data frame from a motion capture database, where the data frame comprises pose data of several parts, the several parts comprising the target part;
determining pose adjustment description information in response to that pose data of the target part in the data frame is different from the pose data label, where the pose adjustment description information refers to information required to adjust the pose data of the target part in the data frame to the pose data label; and
determining the reference pose data corresponding to the sample image based on the pose adjustment description information and the data frame.

In a possible implementation, a training process for the first pose determination model comprises:
determining a pose prediction result based on the first pose determination model, the image feature, and the reference pose data, where the pose prediction result is used to describe a predicted pose of the target part in the sample image; and

updating the first pose determination model based on the pose prediction result and the pose data label.

In a possible implementation, the reference pose data comprises associated part pose data, the associated part pose data being used to describe an actual pose of a reference part associated with the target part; and
the determining a pose prediction result based on the first pose determination model, the image feature, and the reference pose data comprises:
processing the image feature and the reference pose data by using the first pose determination model to obtain a local pose prediction result, where the local pose prediction result is used to describe a predicted rotation state of the target part relative to the reference part; and
determining the pose prediction result based on the local pose prediction result and the associated part pose data.

In a possible implementation, the reference pose data further comprises historical local pose data and a historical local pose change rate; and
the processing the image feature and the reference pose data by using the first pose determination model to obtain a local pose prediction result comprises:
inputting the image feature and the reference pose data into the first pose determination model to obtain a predicted local pose change rate output by the first pose determination model; and
determining the local pose prediction result based on the predicted local pose change rate and the historical local pose data.

In a possible implementation, the reference pose data further comprises a historical local pose change acceleration; and
the inputting the image feature and the reference pose data into the first pose determination model to obtain a predicted local pose change rate output by the first pose determination model comprises:
inputting the image feature and the reference pose data into the first pose determination model to obtain a predicted local pose change acceleration output by the first pose determination model; and
determining the predicted local pose change rate based on the predicted local pose change acceleration and the historical local pose change rate.

In a possible implementation, the historical local pose data is used to describe a historical rotation state of the target part relative to the reference part.

In a possible implementation, the pose recognition model comprises a feature extraction module; and the second pose determination model comprises the feature extraction module and the trained first pose determination model.

In a possible implementation, before the extracting an image feature from the sample image by using a pose recognition model that is pre-constructed, the method further comprises:
training the pose recognition model by using the sample image and the pose data label corresponding to the sample image, where the pose recognition model is configured to perform global pose determination processing of the target part on input data of the pose recognition model.

The present application provides a pose determination method. The method comprises:
obtaining a to-be-processed image and reference pose data corresponding to the to-be-processed image, where the to-be-processed image is used to describe a target part of a second object; and
determining pose representation data corresponding to the to-be-processed image based on a second pose determination model that is pre-constructed, the to-be-processed image, and the reference pose data corresponding to the to-be-processed image, where the second pose determination model is constructed by using the model construction method according to the present application.

The present application provides a model construction apparatus, comprising:
a first obtaining unit configured to obtain a sample image, a pose data label corresponding to the sample image, and reference pose data corresponding to the sample image, where the sample image is used to describe a target part of a first object; and the pose data label is used to describe an actual pose of the target part in the sample image;
a feature extraction unit configured to extract an image feature from the sample image by using a pose recognition model that is pre-constructed;
a model training unit configured to train a first pose determination model by using the image feature, the reference pose data, and the pose data label; and
a model determination unit configured to determine a second pose determination model based on the pose recognition model and a trained first pose determination model.

The present application provides a pose determination apparatus, comprising:
a second obtaining unit configured to obtain a to-be-processed image and reference pose data corresponding to the to-be-processed image, where the to-be-processed image is used to describe a target part of a second object; and
a pose determination unit configured to determine pose representation data corresponding to the to-be-processed image based on a second pose determination model that is pre-constructed, the to-be-processed image, and the reference pose data corresponding to the to-be-processed image, where the second pose determination model is constructed by using the model construction method according to the present application.

The present application provides an electronic device. The device comprises: a processor and a memory, where
the memory is configured to store instructions or a computer program; and
the processor is configured to execute the instructions or the computer program in the memory to cause the electronic device to execute program code of the model construction method or the pose determination method according to the present application.

The present application provides a computer-readable medium, where the computer-readable medium stores instructions or a computer program that, when run on a device, cause the device to execute program code for the model construction method or the pose determination method according to the present application.

The present application provides a computer program product, which comprises a computer program carried on a non-transitory computer-readable medium, where the computer program comprises program code for performing the model construction method or the pose determination method according to the present application.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may derive other drawings from these accompanying drawings without creative efforts.

FIG. 1 is a schematic diagram of a pose prediction process according to an embodiment of the present application;

FIG. 2 is a flowchart of a model construction method according to an embodiment of the present application;

FIG. 3 is a schematic diagram of another pose prediction process according to an embodiment of the present application;

FIG. 4 is a schematic diagram of a further pose prediction process according to an embodiment of the present application;

FIG. 5 is a flowchart of a pose determination method according to an embodiment of the present application;

FIG. 6 is a schematic diagram of a structure of a model construction apparatus according to an embodiment of the present application;

FIG. 7 is a schematic diagram of a structure of a pose determination apparatus according to an embodiment of the present application; and

FIG. 8 is a schematic diagram of a structure of an electronic device according to an embodiment of the present application.

### DETAILED DESCRIPTION

In order to facilitate understanding of the technical solutions according to the present application, some technical terms involved in the present application are introduced first below.

Global pose refers to rotation information of a certain part (e.g., a wrist, etc.) relative to a coordinate system in an image capture device (e.g., a camera, etc.). For example, in some application scenarios, the global pose of the wrist refers to the rotation information of the wrist relative to the camera coordinate system.

Local pose refers to rotation information of a certain part (e.g., the wrist) relative to its parent node. For example, if the parent node of a finger is the wrist, the local pose of the finger refers to rotation information of the finger relative to the wrist. For another example, if the parent node of the wrist is the lower arm, the local pose of the wrist refers to rotation information of the wrist relative to the lower arm. Furthermore, the global pose of the wrist can be determined by Formula (1) as described below.

$${P}_{wrist}^{t} = {P}_{larm}^{t} * {\hat{P}}_{wrist}^{t} \qquad ( 1 )$$

In the formula, t represents a temporal identifier of data (e.g., the frame number of image data being processed in an image sequence);

$${P}_{wrist}^{t}$$

represents the global pose of the wrist at the timing identified by t;

$${P}_{larm}^{t}$$

represents the global pose of the lower arm at the timing identified by t; and

$${\hat{P}}_{wrist}^{t}$$

represents the local pose of the wrist at the timing identified by t.

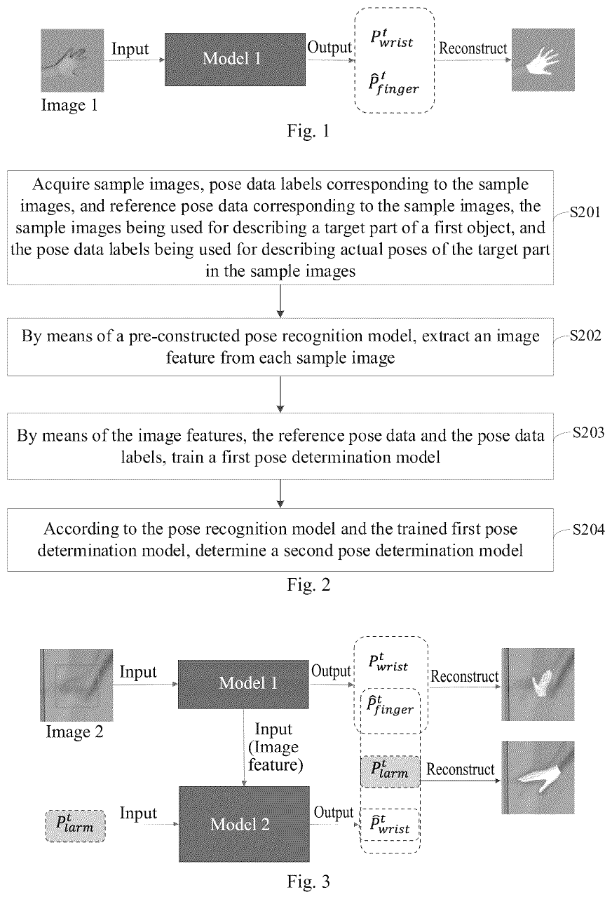

It should be noted that, for FIG. 1,

$${\hat{P}}_{finger}^{t}$$

refers to the local pose of the finger at the timing identified by t; and

$${P}_{wrist}^{t}$$

refers to the global pose of the wrist at the timing identified by t.

It should also be noted that, for an object (e.g., an animal, an object, a person, etc.), if the object is composed of multiple parts, the object may be represented by using a tree structure, so that each part of the object can be treated as a node in the tree structure, and the association relationship between different parts of the object is treated as a connection relationship between different nodes in the tree structure. This allows for the existence of a parent-child node relationship in the tree structure. For example, the lower arm is the parent node of the wrist.

Through research, it has been found that, in some application scenarios, some image data (e.g., the image 1 shown in FIG. 1) and pose labels (e.g., the hand pose label, etc.) annotated for these image data may be used to train a neural network, so as to enable the trained neural network (e.g., the model 1 shown in FIG. 1) to be used to predict pose information of a certain part (e.g., the global pose of the wrist, etc.). This allows a digital model corresponding to the part to be subsequently reconstructed based on the pose information.

Through further research, it has been found that, for the technical solution illustrated in the above paragraph, because this solution only predicts pose information of a certain part based on a local image of that part (e.g., the local hand image shown in FIG. 1), the solution has a relatively high requirement for the local image (e.g., the local image needs to have relatively high image quality). As a result, when the local image (e.g., a local image cropped from a full-body image that has relatively low image quality, an image in which a part is occluded, etc.) cannot meet the requirement, it may easily lead to pose prediction errors (e.g., the predicted pose exhibits obvious unnatural phenomena) or an inability to perform pose prediction, which results in a relatively poor pose prediction effect.

Based on the above researches, in order to better improve the pose prediction effects, the present application provides a model construction method and a pose determination method, which may specifically be as follows: after obtaining a sample image, first, extracting an image feature from the sample image by using a pose recognition model that is pre-constructed, so that the image feature can better represent the pose of a target part (e.g., a wrist) in the sample image; then training a first pose determination model by using the image feature, reference pose data (e.g., pose data regarding the pose of a lower arm, the pose of the wrist in a preceding frame of image, the pose change situation of the wrist in the preceding frame of image, etc.) corresponding to the sample image, and a pose data label (i.e., a pose label) corresponding to the sample image, so as to enable the first pose determination model to learn how to perform local pose prediction processing based on the reference pose data during the training process, so that the trained first pose determination model can better predict the pose of the target part (particularly, the rotation state presented by the target part relative to the lower arm, etc.); and finally, determining a second pose determination model by using the pose recognition model and the trained first pose determination model, so that the second pose determination model can better predict the pose of the target part in image data based on the image data and the corresponding reference pose data, thereby allowing the second pose determination model to have a relatively good pose prediction function. Subsequently, with the aid of a processing process performed by the second pose determination model on a to-be-processed image and reference pose data corresponding to the to-be-processed image, pose representation data corresponding to the to-be-processed image can be determined, so as to enable the pose representation data to better represent the pose of the target part in the to-be-processed image, thereby implementing a pose determination process for a certain part.

As can be seen, since the above second pose determination model performs prediction processing of the pose of the target part in image data based on reference pose data corresponding to the image data, so that the model can perform pose prediction based on as much information as possible, the pose predicted by the model is enabled to be more accurate, thereby contributing to improved pose prediction effects.

Additionally, the present application does not impose limitations on the executing entity for the model construction method. For example, the model construction method according to an embodiment of the present application may be applied to a device having a data processing function, such as a terminal device or a server. For another example, the model construction method according to an embodiment of the present application may also be implemented with the aid of a data communication process between different devices (e.g., a terminal device and a server, two terminal devices, or two servers). Herein, the terminal device may be a smartphone, a computer, a personal digital assistant (PDA) or a tablet. The server may be a stand-alone server, a cluster server, or a cloud server.

In addition, the present application does not impose limitations on an execution entity for the pose determination method. For example, the pose determination method according to an embodiment of the present application may be applied to a device having a data processing function, such as a terminal device or a server. For another example, the pose determination method according to the embodiment of the present application may also be implemented with the aid of a data communication process between different devices (e.g., a terminal device and a server, two terminal devices, or two servers).

In order for persons skilled in the art to better understand the solutions of the present application, the technical solutions in the embodiments of the present application will be described below clearly and completely with reference to the accompanying drawings in the embodiments of the present application. Apparently, the embodiments described are merely some rather than all of the embodiments of the present application. All other embodiments obtained by persons of ordinary skill in the art based on the embodiments of the present application without creative efforts fall within the scope of protection of the present application.

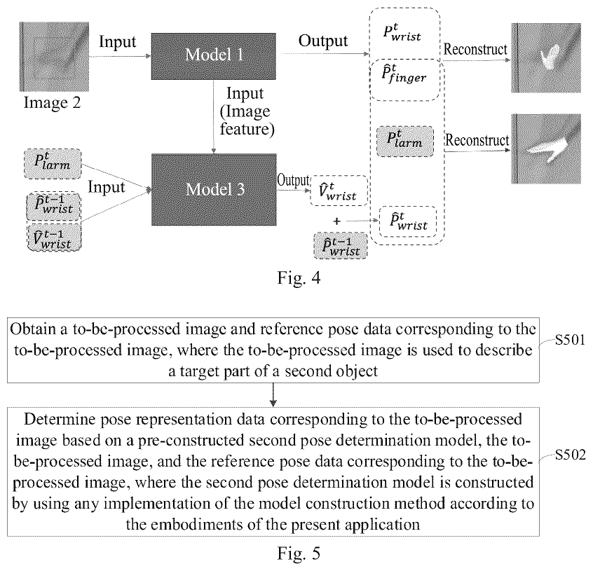

For a better understanding of the technical solutions according to the present application, the model construction method according to the present application is first described below in conjunction with the accompanying drawings. As shown in FIG. 2, the model construction method according to an embodiment of the present application comprises S201 to S204 as described below. FIG. 2 is a flowchart of a model construction method according to this embodiment of the present application.

S201: Obtain a sample image, a pose data label corresponding to the sample image, and reference pose data corresponding to the sample image, where the sample image is used to describe a target part of a first object; and the pose data label is used to describe an actual pose of the target part in the sample image.

The sample image refers to image data required to construct a second pose determination model as described below. Furthermore, the sample image is used to describe the target part of the first object. The first object refers to an object described by the sample image. Furthermore, the present application does not impose limitations on the first object, which may be, for example, a person, an animal, an object, a doll, a virtual character, etc. It should be noted that the present application does not impose limitations on the target part, which may be, for example, any part (e.g., a wrist) existing in the object. It should also be noted that for relevant content of the second pose determination model, reference can be made to S204 as described below, which will not be repeated herein for the sake of brevity.

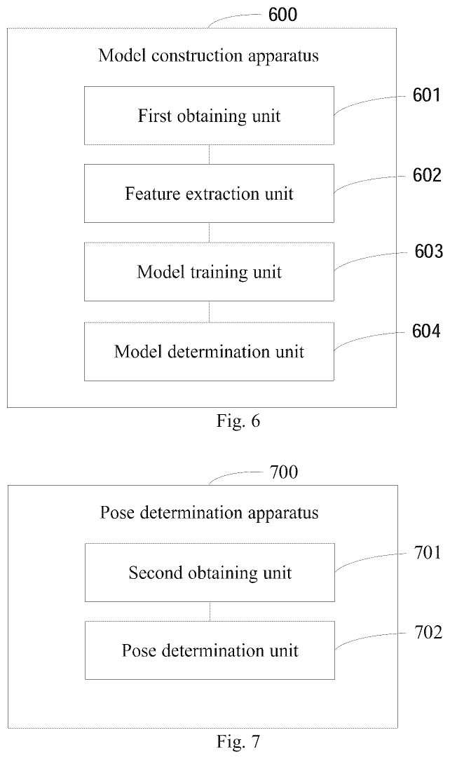

Additionally, the present application does not impose limitations on the sample image. For example, when the above target part is the wrist, the sample image may be image data comprising the wrist (e.g., image 2 shown in FIG. 3).

Additionally, the present application does not impose limitations on the number of the above sample image, which may be, for example, determined based on the actual application scenario. That is, several sample images may be used in the construction process for the second pose determination model.

The pose data label corresponding to the sample image is used to describe the actual pose of the target part in the sample image, so that the “pose data label corresponding to the sample image” is used as guidance information in the construction process for the second pose determination model.

The reference pose data corresponding to the sample image refers to pose information required for reference when performing pose prediction processing for the sample image.

Additionally, the present application does not impose limitations on the implementation of the above “reference pose data corresponding to the sample image”, which may, for example, specifically comprise at least one of the group consisting of associated part pose data corresponding to the sample image and historical reference data corresponding to the sample image. For ease of understanding, these two types of information are introduced below.

The associated part pose data corresponding to the sample image is used to describe an actual state of a reference part associated with the target part, for example, an actual pose of the reference part in the to-be-used image. The reference part refers to a part associated with the target part, and the reference part and the target part belong to the same object. Additionally, the present application does not impose limitations on the reference part. For example, the reference part (e.g., a lower arm) may be a parent node of the target part (e.g., the wrist). The to-be-used image is used to describe at least two parts of the first object, the at least two parts comprising the target part (e.g., the wrist) and the reference part (e.g., the lower arm), and the sample image is determined based on the to-be-used image, so that the sample image is used to describe the entire region or a portion of the region in the to-be-used image.

Based on the content in the above paragraph, it can be seen that if the target part and the reference part exist in the above sample image, the above to-be-used image and the sample image may refer to the same image data, or the sample image may refer to an image cropped from the to-be-used image. However, if the reference part does not exist in the above sample image, the sample image may refer to an image cropped from the to-be-used image, so that the sample image can be used to describe a portion of the region in the to-be-used image. As can be seen, in a possible implementation, if the sample image is the image 2 shown in FIG. 3, the to-be-used image may refer to full-body image data, and the image 2 is an image cropped from the full-body image data.

Additionally, the present application does not impose limitations on the implementation of the above “associated part pose data corresponding to the sample image”. For example, when the above reference part is the lower arm, the “associated part pose data corresponding to the sample image” may be

$${P}_{larm}^{t}$$

shown in FIG. 3.

In addition, the present application does not impose limitations on a method of obtaining the above “associated part pose data corresponding to the sample image”, which may be, for example, implemented by using any existing or future method (e.g., manual annotation, etc.) capable of obtaining pose data of a part. For example, in order to better reduce the difficulty of obtaining the data, the “associated part pose data corresponding to the sample image” may be determined with the aid of a pre-constructed motion capture database (i.e., a determination process illustrated in step 11 and step 12 as described below or a determination process illustrated in step 21 to step 23 as described below). Please refer to the following for relevant content.

Based on the relevant content of the above “associated part pose data corresponding to the sample image”, it can be seen that in a possible implementation, when performing pose prediction processing of the target part for the sample image, reference may be made to the associated part pose data corresponding to the sample image, so that the pose prediction processing may be performed under a physiological structure constraint, which is conducive to better improving the pose prediction accuracy.

Since the above reference pose data comprises the actual pose of the reference part (e.g., the lower arm) associated with the target part, so that the first pose determination model trained based on the reference pose data can learn the physiological structure constraint of the target part, the first pose determination model is enabled to have better pose prediction performance, which in turn allows the second pose determination model determined based on the first pose determination model to also have better pose prediction performance.

The historical reference data corresponding to the sample image is used to describe the historical state of the target part in the sample image, for example, the state of the target part in the sample image over a historical time period (e.g., pose data, a pose change rate, a pose change acceleration, etc.). Here, the historical time period refers to a time period before the state of the target part in the sample image is reached (e.g., before an acquisition moment of the sample image). Furthermore, the present application does not impose limitations on the historical time period, which may, for example, at least comprise an acquisition moment of a preceding frame of image data corresponding to the sample image.

Additionally, the present application does not impose limitations on the implementation of the above “historical reference data corresponding to the sample image”, which may, for example, comprise at least one of the group consisting of historical pose data, a historical pose change rate, and a historical pose change acceleration. Here, the historical pose data is used to describe the pose of the target part over the historical time period. Furthermore, the present application does not impose limitations on the historical pose data, which may, for example, comprise historical local pose data and/or historical global pose data. The historical local pose data refers to the local pose of the target part over the historical time period, so that the historical pose data is used to describe the rotation state of the target part relative to the reference part in the historical time period, that is, the historical rotation state of the target part relative to the reference part. The historical global pose data refers to the global pose of the target part over the historical time period. The historical pose change rate is used to describe a pose change rate presented by the target part over the historical time period. Furthermore, the present application does not impose limitations on the historical pose change rate, which may, for example, comprise a historical local pose change rate and/or a historical global pose change rate. The historical local pose change rate refers to a local pose change rate presented by the target part over the historical time period. The historical global pose change rate refers to a global pose change rate presented by the target part over the historical time period. The historical pose change acceleration is used to describe a pose change acceleration presented by the target part over the historical time period. Furthermore, the present application does not impose limitations on the historical pose change acceleration, which may, for example, comprise a historical local pose change acceleration and/or a historical global pose change acceleration. The historical local pose change acceleration refers to a local pose change acceleration presented by the target part over the historical time period. The historical global pose change rate refers to a global pose change acceleration presented by the target part over the historical time period.

Additionally, the present application does not impose limitations on the method of obtaining the above “historical reference data corresponding to the sample image”, which may be, for example, implemented by using any existing or future method (e.g., manual annotation, etc.) capable of obtaining historical pose information of a part. For another example, in order to better reduce the difficulty of obtaining the data, the “historical reference data corresponding to the sample image” may be determined with the aid of a pre-constructed motion capture database (i.e., a determination process illustrated in step 11 and step 12 as described below or a determination process illustrated in step 21 to step 23 as described below). Please refer to the following for relevant content.

Based on the relevant content of the above “historical reference data corresponding to the sample image”, it can be seen that in a possible implementation, when performing pose prediction processing of the target part for the sample image, reference may be made to the historical state information (e.g., the historical pose data, the historical pose change rate, the historical pose change acceleration, etc.) corresponding to the target part in the sample image, so that the pose prediction processing may be performed under a temporal continuity constraint, which is conducive to better improving the pose prediction accuracy.

Since the above reference pose data comprises the historical reference data (e.g., the pose of the wrist in the preceding frame of image, the pose change rate of the wrist in the preceding frame of image, the pose change acceleration of the wrist in the preceding frame of image, etc.), so that the first pose determination model trained based on the historical reference data can learn the temporal change continuity corresponding to the target part, the first pose determination model is enabled to have better pose prediction performance, which in turn allows the second pose determination model determined based on the first pose determination model to also have better pose prediction performance.

Based on the relevant content of the above “reference pose data corresponding to the sample image”, it can be seen that in a possible implementation, the “reference pose data corresponding to the sample image” may comprise the associated part pose data corresponding to the sample image, so that the pose prediction processing process for the sample image can be performed under the physiological structure constraint. In another possible implementation, the “reference pose data corresponding to the sample image” may further comprise the associated part pose data corresponding to the sample image and the historical reference data corresponding to the sample image, so that the pose prediction processing process for the sample image can be performed under the physiological structure constraint and the temporal continuity constraint.

In practice, in order to better reduce the difficulty of obtaining the training data, the present application further provides two possible implementations of the obtaining process for the above “reference pose data corresponding to the sample image”, which are introduced below separately.

In a possible implementation, the obtaining process for the above “reference pose data corresponding to the sample image” may comprise step 11 and step 12 as described below.

Step 11: Match the pose data label corresponding to the sample image with at least one data frame in a motion capture database, where the data frame comprises pose data of several parts, the several parts comprising the target part.

Here, the motion capture database is a data set constructed by performing motion capture on an object wearing a preset device, so that the motion capture database records a compositional structure of the object (e.g., an animal body, a human body, etc.), pose information of the object, and motion information (e.g., the speed, the acceleration, and other information) of the object. This enables physiological structure constraint learning between different parts of the object and temporal continuity learning between different actions to be subsequently performed based on the motion capture database.

The data frame refers to a record in the motion capture database that is used to describe an actual state (e.g., the pose or motion state, etc.) of each part of the object when the object is in a certain action state. As can be seen, the data frame at least comprises pose data and/or motion data of several parts of the object.

Additionally, the present application does not impose limitations on the implementation of the above step 11, which may specifically be, for example, as follows. After obtaining the pose data label (i.e., the pose label) corresponding to the sample image, the pose data label can be compared with pose data recorded for the target part in each data frame in the motion capture database, so that when it is determined that there exists a data frame in the motion capture database whose pose data recorded for the target part is consistent with the pose data label, it can be determined that there exists a data frame in the motion capture database that matches the pose data label. This enables the reference pose data corresponding to the sample image to be subsequently determined based on the matching data frame.

Step 12; Determine, in response to that there is a data frame in the motion capture database that matches the pose data label, the reference pose data corresponding to the sample image based on the matching data frame.

For ease of understanding, an illustration is given below in conjunction with two examples.

Example 1: When the reference pose data corresponding to the above sample image at least comprises the associated part pose data corresponding to the sample image, and the several parts involved in the data frames in the above motion capture database at least comprise the target part and the reference part, the above step 12 may specifically be as follows. In response to that there exists a data frame in the motion capture database that matches the above “pose data label corresponding to the sample image”, it can be determined that the pose data recorded for the target part in the matching data frame is consistent with the above “pose data label corresponding to the sample image”. Thus, it can be determined that the state of the target part described in the matching data frame is the same as that of the target part in the sample image. Consequently, it can be inferred that the state of the reference part described in the matching data frame should also be the same as that of the reference part corresponding to the target part in the sample image. Therefore, the pose data of the reference part in the matching data frame can be directly determined as the associated part pose data corresponding to the sample image. In this way, the purpose of determining the pose label of the reference part with the aid of the motion capture database can be achieved, thereby effectively reducing the difficulty of obtaining the pose label of the reference part.

Example 2: When the reference pose data corresponding to the above sample image at least comprises the historical reference data corresponding to the sample image, the above step 12 may specifically be as follows. In response to that there exists a data frame in the motion capture database that matches the above “pose data label corresponding to the sample image”, it can be determined that the pose data recorded for the target part in the matching data frame is consistent with the above “pose data label corresponding to the sample image”. Thus, it can be determined that the state of the target part described in the matching data frame is the same as that of the target part in the sample image. Consequently, it can be determined that the preceding N data frames corresponding to the matching data frame can describe the historical state (e.g., the historical pose data, the historical pose change rate, the historical pose change acceleration, etc.) of the target part in the sample image. Therefore, the historical reference data corresponding to the sample image can be directly determined based on the preceding N data frames. Here, the N is a positive integer, for example, N=1, or N>1, and the present application does not impose any specific limitation thereon. It should be noted that the acquisition time of each of the preceding N data frames corresponding to the matching data frame is earlier than the acquisition time of the matching data frame.

Based on the relevant content of the above step 11 and step 12, it can be seen that in some application scenarios, after obtaining a sample image, a data frame consistent with the current pose presented by the target part in the sample image can be matched from a pre-constructed motion capture database based on that current pose, and reference pose data corresponding to the sample image can be determined by using the matched data frame and the historical data frame (e.g., the preceding data frame, etc.) corresponding to the data frame, so that the reference pose data can assist in the pose prediction processing process for the sample image, which is conducive to improving the pose prediction accuracy.

In another possible implementation, the obtaining process for the above “reference pose data corresponding to the sample image” may comprise the step 21 to step 23 as described below.

Step 21: Randomly select a data frame from a motion capture database, where the data frame comprises pose data of several parts, the several parts comprising the target part.

In the present application, after obtaining the pose data label corresponding to the sample image, a data frame can be randomly selected from the motion capture database, thereby enabling the reference pose data corresponding to the sample image to be determined with the aid of the data frame and the preceding N data frames corresponding to the data frame.

Step 22: Determine pose adjustment description information in response to that pose data of the target part in the above data frame is different from the pose data label corresponding to the sample image, where the pose adjustment description information refers to information required to adjust the pose data of the target part in the data frame to the pose data label.

Here, the pose adjustment description information is used to indicate an adjustment method (e.g., a rotation matrix) by which the pose data of the target part in the above data frame can be adjusted to the pose data label corresponding to the above sample image. That is, after the data frame is adjusted based on the pose adjustment description information, pose data of the target part in the adjusted data frame remains consistent with the pose data label corresponding to the sample image.

Additionally, the present application does not impose limitations on a method for obtaining the above pose adjustment description information, which, for example, may specifically be as follows. Rotation processing is performed on the above data frame until it is determined that the pose data of the target part in the data frame is consistent with the pose data label corresponding to the above sample image, at which point the rotation is stopped, and the rotation matrix used in the rotation processing process is determined as the above pose adjustment description information, thereby enabling the pose adjustment description information to indicate that the pose data of the target part in the data frame can be adjusted to the pose data label corresponding to the sample image based on the rotation matrix.

Step 23: Determine the reference pose data corresponding to the sample image based on the above pose adjustment description information and the above data frame.

For ease of understanding, an illustration is given below in conjunction with two examples.

Example 1: When the reference pose data corresponding to the above sample image at least comprises the associated part pose data corresponding to the sample image, and the several parts involved in the data frames in the above motion capture database at least comprise the target part and the reference part, the above step 23 may specifically be as follows. After obtaining the above pose adjustment description information, adjustment processing can be performed on the pose data of the reference part in the above randomly selected data frame based on the pose adjustment description information, so as to obtain the associated part pose data corresponding to the sample image.

Example 2: When the reference pose data corresponding to the above sample image at least comprises the historical reference data corresponding to the sample image, and the historical reference data comprises the historical local pose data, the historical local pose change rate, and the historical local pose change acceleration, the above step 23 may specifically be as follows. After obtaining the above pose adjustment description information, the pose data of the target part in the preceding N data frames corresponding to the above randomly selected data frame can be adjusted based on the pose adjustment description information to obtain the historical data corresponding to the sample image, and the historical local pose data (e.g., the local pose of the wrist in the preceding frame), the historical local pose change rate (e.g., a local pose change rate of the wrist in the preceding frame or a local pose change rate shown in Formula (2) as described below), and the historical local pose change acceleration (e.g., a local pose change acceleration of the wrist in the preceding frame or a local pose change acceleration shown in Formula (3) as described below), which correspond to the sample image, are determined based on these historical data.

$${\hat{V}}_{wrist}^{t - 1} = {\hat{P}}_{wrist}^{t - 1} - {\hat{P}}_{wrist}^{t - 2} \qquad ( 2 )$$

$${\hat{a}}_{wrist}^{t - 1} = {\hat{V}}_{wrist}^{t - 1} - {\hat{V}}_{wrist}^{t - 2} \qquad ( 3 )$$

where t−1 represents a temporal identifier of the preceding piece of data; t−2 represents a temporal identifier of the preceding two pieces of data;

$${\hat{P}}_{wrist}^{t - 1}$$

represents the local pose of the wrist at the timing identified by t−1;

$${\hat{P}}_{wrist}^{t - 2}$$

represents the local pose of the wrist at the timing identified by t−2;

$${\hat{V}}_{wrist}^{t - 1}$$

represents the local pose change rate of the wrist at the timing identified by t−1;

$${\hat{V}}_{wrist}^{t - 2}$$

represents the local pose change rate of the wrist at the timing identified by t−2; and

$${\hat{a}}_{wrist}^{t - 1}$$

represents the local pose change acceleration of the wrist at the timing identified by t−1.

Based on the relevant content of the above step 21 to step 23, it can be seen that in some application scenarios, after obtaining a sample image, a data frame can be randomly selected from the pre-constructed motion capture database; then, rotation processing is performed on the data frame based on the pose data label corresponding to the sample image, so that the pose data of the target part in the data frame is rotated to be consistent with the pose data label corresponding to the sample image. This enables the reference pose data corresponding to the sample image to be subsequently determined based on the rotation matrix used in the rotation processing, the data frame, and a historical data frame (e.g., the preceding N data frames, etc.) corresponding to the data frame, so that the reference pose data can assist in a pose prediction processing process for the sample image, which is conducive to improving the pose prediction accuracy.

Based on the relevant content of the reference pose data corresponding to the above sample image, it can be seen that in some application scenarios, reference pose data corresponding to any sample image can be determined with the aid of the pre-constructed motion capture database. Here, since the motion capture database is a database that is relatively easy to obtain and has relatively rich data, the determination process for the reference pose data based on the motion capture database is relatively easy to implement. This can effectively reduce the difficulty of obtaining the reference pose data, thereby effectively avoiding adverse effects associated with manual annotation of the reference pose data (e.g., high costs, difficulty in obtaining, etc.), and consequently effectively lowering the threshold for model training.

Because the reference pose data involved in the model construction process can be automatically determined with the aid of the motion capture database, this can effectively avoid the impact caused by manual annotation of the pose (e.g., relatively high difficulty, etc.), thereby effectively reducing the training difficulty of the above second pose determination model.

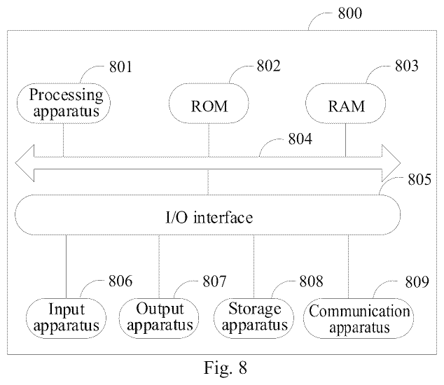

Based on the relevant content of the above S201, it can be seen that in some application scenarios (e.g., a hand reconstruction scenario, etc.), in order to construct a model with relatively good pose prediction performance for the target part (e.g., the wrist), some sample images (e.g., the image 2 shown in FIG. 3 and FIG. 4), and pose data labels corresponding to the sample images, and reference pose data

$$( e . g . , {P}_{larm}^{t} , {\hat{P}}_{wrist}^{t - 1} , {\hat{V}}_{wrist}^{t - 1} , etc . shown in Fig . 4 )$$

corresponding to the sample images can be obtained first, thereby enabling model training processing to be subsequently performed based on these three pieces of information.

S202: Extract an image feature from the sample image by using a pose recognition model that is pre-constructed.

The pose recognition model is configured to perform pose prediction processing of at least one part (e.g., global pose prediction processing of the wrist or local pose prediction processing of the finger, etc.) for input data of the pose recognition model; and the at least one part at least comprises the above target part.

As may be seen, in a possible implementation, the above pose recognition model can be specifically configured to perform global pose prediction processing of the target part for the input data of the pose recognition model. For example, the pose recognition model may be the model 1 shown in FIG. 1, FIG. 3, and FIG. 4.

Additionally, the present application does not impose limitations on the implementation of the above pose recognition model, which may be, for example, implemented by using any existing or future model capable of performing global pose prediction processing on the target part.

In addition, the present application does not impose limitations on the construction process for the above pose recognition model, which may be, for example, implemented by using any existing or future construction method capable of constructing a model for global pose prediction processing for the target part.

Furthermore, the present application does not impose limitations on the model structure of the above pose recognition model. For example, the pose recognition model may comprise a feature extraction module and a pose prediction module, and input data of the pose prediction module comprises output data of the feature extraction module. Here, the feature extraction module is configured to perform feature extraction processing on input data of the feature extraction module; and the pose prediction module is configured to perform pose determination processing based on the input data of the pose prediction module. It should be noted that the present application does not impose limitations on the implementations of the feature extraction module and the pose prediction module. For example, the feature extraction module may be implemented by using a backbone network.

The image feature refers to an intermediate feature generated when the above pose recognition model processes the sample image, so that the image feature can represent image information carried by the sample image, thereby enabling the image feature to better represent the pose of the target part in the sample image. Furthermore, the present application does not impose limitations on the method for extracting the image feature. For example, when the pose recognition model comprises the feature extraction module, the process of obtaining the image feature may specifically be as follows: performing feature extraction processing on the sample image by using the feature extraction module to obtain the image feature corresponding to the sample image, so that the image feature can better represent the image information carried by the sample image.

Based on the relevant content of the above S202, it can be seen that in some application scenarios, after obtaining a sample image, the sample image can be processed by using the pre-constructed pose recognition model (e.g., the model 1 shown in FIG. 3 or FIG. 4) to obtain an image feature corresponding to the sample image, so that the image feature can better represent image information carried by the sample image, thereby enabling the rotation state presented by the target part in the sample image relative to a reference part to be subsequently determined based on the image feature.

S203: Train a first pose determination model by using the image feature, the reference pose data, and the pose data label.

The first pose determination model is configured to perform determination processing of the pose information (e.g., the local pose, the pose change rate, or the pose change acceleration, etc.) of the target part based on input data of the first pose determination model. For example, the first pose determination model may be the model 2 shown in FIG. 3 or the model 3 shown in FIG. 4.

Additionally, the present application does not impose limitations on the model structure of the above first pose determination model.

In addition, the present application does not impose limitations on the model training process for the above first pose determination model.

In practice, in order to better improve the model training effect, the present application further provides a possible implementation of the above S203, which may specifically comprise step 31 to step 33 as described below.

Step 31: Determine a pose prediction result based on the first pose determination model, the above image feature, and the above reference pose data, where the pose prediction result is used to describe a predicted pose of the target part in the sample image.

Here, the pose prediction result is used to describe the predicted pose of the target part in the sample image. As can be seen, in a possible implementation, the pose prediction result may refer to the global pose of the target part predicted for the sample image.

Additionally, the present application does not impose limitations on the implementation of the above step 31. For ease of understanding, an illustration is given below in conjunction with two examples.

As an example, when the reference pose data corresponding to the above sample image at least comprises the associated part pose data, the step 31 may specifically comprise step 311 and step 312 as described below.

Step 311: Process the image feature and the reference pose data by using the first pose determination model to obtain a local pose prediction result, where the local pose prediction result is used to describe a predicted rotation state of the target part relative to the reference part.

Here, the local pose prediction result is used to describe the predicated rotation state of the target part in the sample image relative to the reference part. For example, the local pose prediction result may be

$${\hat{P}}_{wrist}^{t}$$

shown in FIG. 3 and FIG. 4.

Additionally, the present application does not impose limitations on the implementation of the above step 311. For example, in some application scenarios (e.g., a scenario where pose prediction is performed based on only the physiological structure constraint), step 311 may specifically be as follows: inputting the image feature of the sample image and the associated part pose data corresponding to the sample image

$$( e . g . , {P}_{larm}^{t} shown in Fig . 3 )$$

into the first pose determination model, so that the first pose determination model performs local pose prediction processing (e.g., the local pose prediction processing shown in FIG. 3) of the target part based on the associated part pose data, and obtains and outputs the local pose prediction result

$$( e . g . , {\hat{V}}_{wrist}^{t} shown in Fig . 3 )$$

of the target part, so as to enable the local pose prediction result to represent the rotation state presented by the target part relative to the reference part.

For example, in some application scenarios (e.g., a scenario where pose prediction is performed based on the physiological structure constraint and the temporal continuity constraint), when the reference pose data corresponding to the above sample image comprises the associated part pose data

$$( e . g . , {P}_{larm}^{t} shown in Fig . 4 ) ,$$

the historical local pose data

$$( e . g . , {\hat{P}}_{wrist}^{t - 1} shown in Fig . 4 ) ,$$

and the historical local pose change rate

$$( e . g . , {\hat{V}}_{wrist}^{t - 1} shown in Fig . 4 ) ,$$

the above step 311 may specifically be as follows: first inputting the image feature of the sample image, the associated part pose data, the historical local pose data, and the historical local pose change rate into the first pose determination model, so that the first pose determination model performs pose change rate prediction processing (e.g., the pose change rate prediction processing shown in FIG. 3) of the target part based on the associated part pose data, the historical local pose data, and the historical local pose change rate, and obtains and outputs a predicted local pose change rate

$$( e . g . , {\hat{V}}_{wrist}^{t} shown in Fig . 4 ) ,$$

so as to enable the predicted local pose change rate to represent the current local pose change rate of the target part in the sample image; then determining the local pose prediction result

$$( e . g . , {\hat{P}}_{wrist}^{t} shown in Fig . 4 )$$

based on the predicted local pose change rate and the historical local pose data, so as to enable the local pose prediction result to represent the rotation state presented by the target part relative to the reference part.

It should be noted that the present application does not impose limitations on the implementation of the step of “determining the local pose prediction result based on the predicted local pose change rate and the historical local pose data” in the above paragraph, which may be, for example, implemented by using Formula (4) as described below.

$${\hat{P}}_{wrist}^{t} = {\hat{P}}_{wrist}^{t - 1} + {\hat{V}}_{wrist}^{t} \qquad ( 4 )$$

In the formula, t represents a temporal identifier of a piece of data; t−1 represents a temporal identifier of the preceding data corresponding to the piece of data;

$${\hat{P}}_{wrist}^{t}$$

represents the local pose of the wrist at the timing identified by t;

$${\hat{P}}_{wrist}^{t - 1}$$

represents the local pose of the wrist at the timing identified by t−1;

$${\hat{V}}_{wrist}^{t}$$

represents the local pose change rate of the wrist at the timing identified by t.

For example, in some application scenarios (e.g., a scenario where pose prediction is performed based on the physiological structure constraint and the temporal continuity constraint), when the reference pose data corresponding to the above sample image comprises the associated part pose data, the historical local pose data, the historical local pose change rate, and the historical local pose change acceleration, the above step 311 may specifically be as follows: first inputting the image feature of the sample image, the associated part pose data, the historical local pose data, the historical local pose change rate, and the historical local pose change acceleration into the first pose determination model, so that the first pose determination model performs pose change acceleration prediction processing of the target part based on the associated part pose data, the historical local pose data, the historical local pose change rate, and the historical local pose change acceleration, and obtains and outputs the predicted local pose change acceleration; next, determining the predicted local pose change rate based on the predicted local pose change acceleration and the historical local pose change rate, so as to enable the predicted local pose change rate to represent the current local pose change rate of the target part in the sample image; then determining the local pose prediction result based on the predicted local pose change rate and the historical local pose data, so as to enable the local pose prediction result to represent the rotation state presented by the target part relative to the reference part.

It should be noted that the present application does not impose limitations on the implementation of the step of “determining the predicted local pose change rate based on the predicted local pose change acceleration and the historical local pose change rate” in the above paragraph, which may be, for example, implemented by using Formula (5) as described below.

$${\hat{V}}_{wrist}^{t} = {\hat{V}}_{wrist}^{t - 1} + {\hat{a}}_{wrist}^{t} \qquad ( 5 )$$

In the formula, t represents a temporal identifier of a piece of data; t−1 represents a temporal identifier of the preceding data corresponding to the piece of data;

$${\hat{V}}_{wrist}^{t}$$

represents the local pose change rate of the wrist at the timing identified by t;

$${\hat{V}}_{wrist}^{t - 1}$$

represents the local pose change rate of the wrist at the timing identified by t−1;

$${\hat{a}}_{wrist}^{t}$$

represents the local pose change acceleration of the wrist at the timing identified by t.

Based on the relevant content of the above step 311, it can be seen that after obtaining an image feature and reference pose data of a sample image, a local pose prediction result of the sample image can be obtained by using the first pose determination model, the image feature, and the reference pose data, so as to enable the local pose prediction result to represent the rotation state presented by the target part relative to the reference part.

Step 312: Determine the pose prediction result based on the above local pose prediction result and the above associated part pose data.

In the present application, after obtaining the above local pose prediction result, the pose prediction result can be determined based on the local pose prediction result and the above associated part pose data, so as to enable the pose prediction result to represent the predicted global pose of the target part in the sample image.

Additionally, the present application does not impose limitations on the implementation of the above step 312, which may be, for example, implemented by using the above Formula (1).

Based on the relevant content of the above steps 311 to step 312, it can be seen that for a sample image, the image feature of the sample image and the reference pose data of the sample image can be processed by using the first pose determination model to obtain the local pose prediction result

$$( e . g . , {\hat{P}}_{wrist}^{t} shown in Fig . 3 or Fig . 4 )$$

of the sample image, so as to enable the local pose prediction result to represent the rotation state presented by the target part relative to the reference part. The pose prediction result is then determined based on the local pose prediction result, so as to enable the pose prediction result to represent the predicted global pose of the target part in the sample image, thereby achieving the purpose of pose prediction processing based on some constraint information (e.g., a physiological structure constraint and a temporal continuity constraint, etc.), which is conducive to improving the pose prediction effect.

Step 32: Determine whether a preset stopping condition is reached, and if so, end the training process for the first pose determination model; if not, execute a step 33 as described below.

Here, the preset stopping condition may be preset, which may, for example, specifically be as follows: a prediction loss of the first pose determination model is lower than a first threshold, or a change rate of the prediction loss of the first pose determination model is lower than a second threshold (i.e., the prediction performance of the first pose determination model reaches convergence), or the number of model updates of the first pose determination model reaches a third threshold.

The prediction loss of the first pose determination model is used to describe the prediction performance of the first pose determination model. Furthermore, the present application does not impose limitations on the determination process for the “prediction loss of the first pose determination model”, which may, for example, specifically be: determining the prediction loss of the first pose determination model based on a difference between the pose prediction result of the sample image and the pose data label corresponding to the sample image.

It should be noted that the present application does not impose limitations on the implementation of the step of “determining the prediction loss of the first pose determination model based on a difference between the pose prediction result of the sample image and the pose data label corresponding to the sample image” in the above paragraph.

Based on the relevant content of the above step 32, it can be seen that for the current round of training process, in response to that it is determined that the preset stopping condition is reached, it can be determined that the current first pose determination model has relatively good prediction performance. Therefore, the training process for the first pose determination model can be directly ended. However, in response to that it is determined that the preset stopping condition has not been met, it can be determined that the prediction performance of the current first pose determination model still needs further improvement. Therefore, step 33 as described below can be directly executed.

Step 33: Update the first pose determination model based on the above pose prediction result and the above pose data label, and return to execute the above step 31 and its subsequent steps.

In the present application, for the current round of training process, in response to that it is determined that the preset stopping condition has not been met, it can be determined that the prediction performance of the current first pose determination model still needs further improvement. Therefore, parameters in the first pose determination model can be updated based on the difference between the pose prediction result of the sample image and the pose data label corresponding to the sample image, so that the parameter-updated first pose determination model has better prediction performance, and the above step 31 and its subsequent steps continue to be executed based on the parameter-updated first pose determination model, so as to start a next round of training process for the first pose determination model, and the iteration is repeated until the preset stopping condition is met, at which point the training process for the first pose determination model can be ended.

Based on the relevant content of the above step 31 to step 33, it can be seen that in some application scenarios, the first pose determination model can be trained by using image features of some sample images, reference pose data corresponding to these sample images, and pose data labels corresponding to these sample images, so that the trained first pose determination model can perform pose prediction processing of the target part based on the image feature of any image data and the reference pose data. Because the reference pose data comprises associated part pose data, the trained first pose determination model learns pose prediction processing based on the physiological structure constraint. Furthermore, since the reference pose data comprises the historical reference data, the trained first pose determination model learns pose prediction processing based on the temporal continuity constraint. This is conducive to improving the prediction performance of the first pose determination model.

S204: Determine a second pose determination model based on the pose recognition model and the trained first pose determination model.

Here, the second pose determination model is configured to perform prediction processing of the pose information (e.g., the local pose, the pose change rate, or the pose change acceleration, etc.) of the target part for input data of the second pose determination model.

Additionally, the present application does not impose limitations on the implementation of the above second pose determination model. For example, the second pose determination model may comprise the pose recognition model and the trained first pose determination model. As can be seen, in a possible implementation, when the above target part is the wrist, the second pose determination model may comprise the pose recognition model and the first pose determination model. This enables the second pose determination model to not only be configured to perform prediction processing for the pose information (e.g., the local pose, the pose change rate, or the pose change acceleration, etc.) of the target part, but also perform local pose prediction processing for the finger, thereby allowing the second pose determination model to be configured to complete pose prediction processing for the hand.

For another example, when the above pose recognition model comprises the feature extraction module, the above second pose determination model may specifically comprise the feature extraction module and the trained first pose determination model. Furthermore, the input data of the first pose determination model comprises output data of the feature extraction module, so that the second pose determination model can at least be configured to implement the prediction processing of the local pose, the pose change rate, or the pose change acceleration of the target part.

Based on the relevant content of the above S201 to S204, it can be seen that for the model construction method according to the embodiment of the present application, after obtaining a sample image, an image feature is first extracted from the sample image by using a pose recognition model that is pre-constructed, so that the image feature can better represent the pose of a target part (e.g., a wrist) in the sample image. Then, a first pose determination model is trained by using the image feature, reference pose data (e.g., pose data regarding the pose of a lower arm, the pose of the wrist in a preceding frame of image, the pose change situation of the wrist in the preceding frame of image, etc.) corresponding to the sample image, and a pose data label (i.e., a pose label) corresponding to the sample image, so as to enable the first pose determination model to learn how to perform local pose prediction processing based on the reference pose data during the training process, so that the trained first pose determination model can better predict the pose of the target part (particularly, the rotation state presented by the target part relative to the lower arm, etc.). Finally, a second pose determination model is determined by using the pose recognition model and the trained first pose determination model, so that the second pose determination model can better predict the pose of the target part in the image data based on the image data and the corresponding reference pose data, thereby allowing the second pose determination model to have a relatively good pose prediction function. Consequently, this enables the pose predicted by the model to be more accurate, which is conducive to improving the pose prediction effect.

In practice, in order to better improve the pose prediction performance of the second pose determination model, the present application further provides a possible implementation of the above model construction method, which may specifically comprise step 41 to step 45 as described below.

Step 41: Obtain a sample image, a pose data label corresponding to the sample image, and reference pose data corresponding to the sample image, where the sample image is used to describe a target part of a first object; and the pose data label is used to describe an actual pose of the target part in the sample image.

It should be noted that for the relevant content of step 41, reference can be made to the above S201.

Step 42: Train the pose recognition model by using the sample image and the pose data label corresponding to the sample image, where the pose recognition model is configured to perform global pose determination processing of the target part on input data of the pose recognition model.

It should be noted that the present application does not impose limitations on the implementation of step 42, which may be, for example, implemented by using any existing or future method capable of training a global pose prediction model based on some image data and their corresponding global pose labels.

Step 43: Extract an image feature from the sample image by using the trained pose recognition model.

It should be noted that for the relevant content of step 43, reference can be made to the above S202.

Step 44: Train a first pose determination model by using the image feature, the reference pose data, and the pose data label.

It should be noted that for the relevant content of step 44, reference can be made to the above S203.

Step 45: Determine a second pose determination model based on the trained pose recognition model and the trained first pose determination model.

It should be noted that for the relevant content of step 45, reference can be made to the above S204.

Based on the relevant content of the above step 41 to step 45, it can be seen that in some application scenarios, the pose recognition model and the first pose determination model can be trained separately with the aid of the same training data set, so as to enable the two models to have relatively good processing performance for image data with certain commonalities. As a result, the two models have relatively good coordination therebetween (e.g., the first pose determination model has relatively good processing performance for an output result of a feature extraction module in the pose recognition model). Consequently, the second pose determination model determined based on the two models has better pose prediction performance, which is conducive to improving the pose prediction effect for the target part.

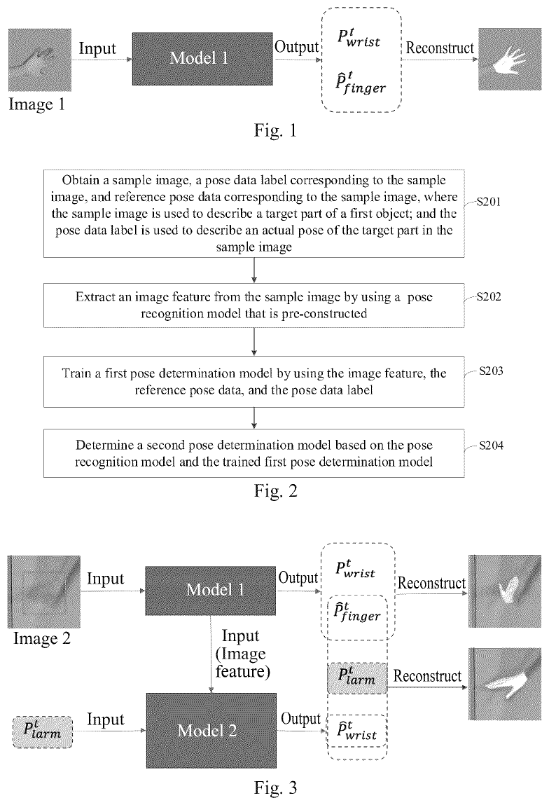

Based on the relevant content of the above model construction method, the present application further provides a pose determination method. For ease of understanding, an illustration is given below in conjunction with the accompanying drawings. As shown in FIG. 5, the pose determination method according to an embodiment of the present application may comprise S501 and S502 as described below.

S501: Obtain a to-be-processed image and reference pose data corresponding to the to-be-processed image, where the to-be-processed image is used to describe a target part of a second object. Here, the to-be-processed image refers to image data that requires pose prediction processing of the target part. Furthermore, the present application does not impose limitations on the to-be-processed image.

The second object refers to an object described by the to-be-processed image. Furthermore, the present application does not impose limitations on the second object. For example, the second object may be a person, an animal, a virtual character, an object, etc.

The reference pose data corresponding to the to-be-processed image refers to information required for reference when performing the pose prediction processing of the target part for the to-be-processed image. Furthermore, the present application does not impose limitations on the “reference pose data corresponding to the to-be-processed image”, which may, for example, comprise at least one of the group consisting of associated part pose data corresponding to the to-be-processed image and historical reference data corresponding to the to-be-processed image.

The associated part pose data corresponding to the to-be-processed image is used to describe a state of a reference part associated with the target part, for example, a pose of the reference part in a to-be-used image corresponding to the to-be-processed image. The to-be-used image corresponding to the to-be-processed image is used to describe at least two parts of the second object, the at least two parts comprising the target part (e.g., the wrist) and the reference part (e.g., the lower arm), and the to-be-processed image is determined based on the to-be-used image, so that the to-be-processed image is used to describe the entire region or a portion of the region in the to-be-used image.

Additionally, the present application does not impose limitations on the obtaining process for the above “associated part pose data corresponding to the to-be-processed image”. For example, when the to-be-used image corresponding to the to-be-processed image is used to describe several parts, and the several parts comprise the target part and the reference part, the obtaining process for the “associated part pose data corresponding to the to-be-processed image” may specifically be as follows: first inputting the to-be-used image corresponding to the to-be-processed image into a pre-constructed multi-part pose prediction model to obtain a multi-part pose prediction result output by the multi-part pose prediction model, so that the multi-part pose prediction result can represent global poses presented by the several parts in the to-be-used image; then determining a pose prediction result of the reference part in the multi-part pose prediction result as the associated part pose data corresponding to the to-be-processed image.

The historical reference data corresponding to the to-be-processed image is used to describe the historical state of the target part in the to-be-processed image, for example, the state of the target part in the to-be-processed image over a historical time period (e.g., pose data, a pose change rate, a pose change acceleration, etc.). Here, the historical time period refers to a time period before the state of the target part in the to-be-processed image is reached. Furthermore, the present application does not impose limitations on the historical time period, which may, for example, refer to an acquisition moment of a preceding frame of image data corresponding to the to-be-processed image.

Additionally, the present application does not impose limitations on the implementation of the above “historical reference data corresponding to the to-be-processed image”, which may, for example, comprise at least one of the group consisting of historical pose data, a historical pose change rate, and a historical pose change acceleration. It should be noted that for the relevant content of the historical pose data, the historical pose change rate, and the historical pose change acceleration, reference can be made to the above.

Additionally, the present application does not impose limitations on the obtaining process for the above “historical reference data corresponding to the to-be-processed image”. For example, when the to-be-processed image is determined by cropping the t^{th} frame of image data in an image sequence, the obtaining process for the “historical reference data corresponding to the to-be-processed image” may specifically be: determining the historical reference data corresponding to the to-be-processed image based on a local pose (e.g., a local pose prediction result, etc.) presented on the target part in the preceding N frames of image data corresponding to the t^{th} frame of image data.

It should be noted that the present application does not impose limitations on the implementation of the step of “determining the historical reference data corresponding to the to-be-processed image based on a local pose in the preceding N frames of image data corresponding to the t^{th} frame of image data” in the above paragraph, which may, for example, specifically be: determining a local pose prediction result presented on the target part in the preceding frame of image data (i.e., the (t−1)^{th} frame of image data) corresponding to the t^{th} frame of image data as the historical local pose data

$$( e . g . , {\hat{P}}_{wrist}^{t - 1} )$$

corresponding to the to-be-processed image; calculating the historical local pose change rate

$$( e . g . , {\hat{V}}_{wrist}^{t - 1} )$$

corresponding to the to-be-processed image by using the local pose prediction result presented on the target part in the preceding two frames of image data (i.e., the (t−1)^{th} frame of image data and the (t−2)^{th} frame of image data) corresponding to the t^{th} frame of image data; and calculating the historical local pose change acceleration

$$( e . g . , {\hat{a}}_{wrist}^{t - 1} )$$

corresponding to the to-be-processed image by using local pose prediction results presented on the target part in the preceding three frames of image data (i.e., the (t−1)^{th} frame of image data, the (t−2)^{th} frame of image data, and the (t−3)^{th} frame of image data) corresponding to the t^{th} frame of image data.

S502: Determine pose representation data corresponding to the to-be-processed image based on a second pose determination model that is pre-constructed, the to-be-processed image, and the reference pose data corresponding to the to-be-processed image, where the second pose determination model is constructed by using any implementation of the model construction method according to the embodiment of the present application.

The pose representation data corresponding to the to-be-processed image is used to represent the global pose of the target part in the to-be-processed image.

Additionally, the present application does not impose limitations on the implementation of the above S502. For ease of understanding, an illustration is given below in conjunction with examples.

As an example, when the above second pose determination model comprises a feature extraction module and the above first pose determination model, and the above reference pose data corresponding to the to-be-processed image at least comprises the associated part pose data corresponding to the to-be-processed image, the above S502 may specifically comprise step 51 to step 52 as described below.

Step 51: Perform, by the feature extraction module, feature extraction processing on the to-be-processed image to obtain an image feature of the to-be-processed image, so that the image feature is used to represent image information carried by the to-be-processed image.

Step 52: Perform, by the first pose determination model, processing based on the reference pose data corresponding to the to-be-processed image and the image feature of the to-be-processed image to obtain a local pose prediction result of the to-be-processed image, so that the local pose prediction result can represent a rotation state presented by the target part in the to-be-processed image relative to a reference part.

It should be noted that an implementation of step 52 is similar to the implementation of the above step 311, and will not be repeated herein for the sake of brevity.

Step 53: Determine the pose representation data corresponding to the to-be-processed image based on the local pose prediction result of the to-be-processed image and the associated part pose data corresponding to the to-be-processed image.

It should be noted that an implementation of step 53 is similar to the implementation of the above step 312, and will not be repeated herein for the sake of brevity.

Based on the relevant content of the above step 51 to step 53, it can be seen that in some application scenarios, after obtaining a to-be-processed image and reference pose data corresponding to the to-be-processed image, the to-be-processed image and the reference pose data corresponding to the to-be-processed image can be input into a second pose determination model that is pre-constructed, so that a feature extraction module in the second pose determination model performs feature extraction processing on the to-be-processed image to obtain an image feature of the to-be-processed image, thereby allowing the image feature to be used to represent image information carried by the to-be-processed image. Then, a local pose prediction result of the to-be-processed image is determined by using a second pose in the second pose determination model, the reference pose data, and the image feature, so that the local pose prediction result can represent a rotation state presented by the target part in the to-be-processed image relative to the reference part. Finally, pose representation data corresponding to the to-be-processed image is determined based on the local pose prediction result and the associated part pose data corresponding to the to-be-processed image, so that the pose representation data can represent a global pose of the target part in the to-be-processed image, thereby enabling reconstruction processing of the target part to be subsequently performed based on the pose representation data.

Based on the relevant content of the above S501 to S502, it can be seen that for the pose determination method according to the embodiment of the present application, after obtaining image data and reference pose data corresponding to the image data, the image data and the reference pose data corresponding to the image data can be processed by using a second pose determination model that is pre-constructed to determine pose representation data corresponding to the image data, so that the pose representation data can better represent a pose of the target part in the image data, thereby implementing a pose determination process for a certain part. Because the second pose determination model performs pose prediction processing on the pose of the target part in the image data based on the reference pose data, the pose representation data predicted by the model can more accurately represent the pose of the target part in the image data, which is conducive to improving the pose prediction effect.

Based on the relevant content of the above pose determination method, it can be seen that it specifically has the following advantages:

1) Because the pose prediction process based on the physiological structure constraint is learned during the construction of the second pose determination model, when the quality of the above to-be-processed image is relatively low (e.g., it is almost impossible to clearly view the pose of the target part), the second pose determination model can still predict the pose information of the target part that complies with the physiological structure constraint based on the associated part pose data corresponding to the to-be-processed image. This can effectively avoid unnatural pose phenomena (e.g., wrist fracture, etc.) caused by the pose information predicted for the target part not complying with the physiological structure constraint, which is conducive to improving the pose prediction effect of the target part.

2) Because the pose prediction process based on the temporal consistency constraint is learned during the construction of the second pose determination model, when the quality of the above to-be-processed image is relatively low, the second pose determination model can still predict the pose information of the target part that complies with the temporal continuity constraint based on the historical reference data corresponding to the to-be-processed image. This is conducive to improving the smoothness of the pose information, thereby improving the pose prediction effect of the target part.

3) Because the reference pose data involved in the construction process of the second pose determination model can be determined with the aid of the motion capture database, this can effectively avoid adverse effects caused by manual annotation of the reference pose data, thereby effectively reducing the difficulty of constructing the second pose determination model.

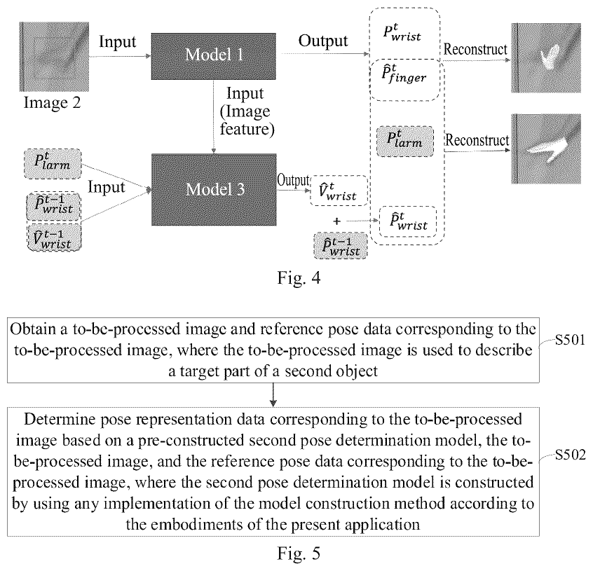

On the basis of the model construction method according to the embodiments of the present application, an embodiment of the present application further provides a model construction apparatus, which is explained and illustrated below in conjunction with FIG. 6. FIG. 6 is a schematic diagram of a structure of a model construction apparatus according to an embodiment of the present application. It should be noted that, for technical details of the model construction apparatus according to this embodiment of the present application, reference can be made to the relevant content of the aforementioned model construction method.

As shown in FIG. 6, the model construction apparatus 600 according to this embodiment of the present application comprises:
a first obtaining unit 601 configured to obtain a sample image, a pose data label corresponding to the sample image, and reference pose data corresponding to the sample image, where the sample image is used to describe a target part of a first object; and the pose data label is used to describe an actual pose of the target part in the sample image;
a feature extraction unit 602 configured to extract an image feature from the sample image by using a pose recognition model that is pre-constructed;
a model training unit 603 configured to train a first pose determination model by using the image feature, the reference pose data, and the pose data label; and
a model determination unit 604 configured to determine a second pose determination model based on the pose recognition model and the trained first pose determination model.

In a possible implementation, the reference pose data comprises at least one of the group consisting of associated part pose data and historical reference data, the associated part pose data being used to describe an actual pose of a reference part associated with the target part in a to-be-used image, where the reference part and the target part belong to the same object; and the to-be-used image is used to describe at least two parts of the first object, the at least two parts comprising the target part and the reference part; and the sample image is determined based on the to-be-used image; and the historical reference data is used to describe a historical state of the target part.

In a possible implementation, the historical reference data comprises at least one of the group consisting of historical pose data, a historical pose change rate, and a historical pose change acceleration. In a possible implementation, the reference part is a parent node of the target part.

In a possible implementation, an obtaining process for the reference pose data comprises:
matching the pose data label with at least one data frame in a motion capture database, where the data frame comprises pose data of several parts, the several parts comprising the target part; and
determining, in response to that there is a data frame in the motion capture database that matches the pose data label, the reference pose data corresponding to the sample image based on the matching data frame.

In a possible implementation, an obtaining process for the reference pose data comprises:
randomly selecting a data frame from a motion capture database, where the data frame comprises pose data of several parts, the several parts comprising the target part;
determining pose adjustment description information in response to that pose data of the target part in the data frame is different from the pose data label, where the pose adjustment description information refers to information required to adjust the pose data of the target part in the data frame to the pose data label; and
determining the reference pose data corresponding to the sample image based on the pose adjustment description information and the data frame.

In a possible implementation, the model training unit 603 comprises:
a first determination sub-unit configured to determine a pose prediction result based on the first pose determination model, the image feature, and the reference pose data, where the pose prediction result is used to describe a predicted pose of the target part in the sample image; and
a model updating sub-unit configured to update the first pose determination model based on the pose prediction result and the pose data label.

In a possible implementation, the reference pose data comprises associated part pose data, the associated part pose data being used to describe an actual pose of the reference part associated with the target part; and
the first determination sub-unit comprises:
a second determination sub-unit configured to process the image feature and the reference pose data by using the first pose determination model to obtain a local pose prediction result, where the local pose prediction result is used to describe a predicted rotation state of the target part relative to the reference part; and
a third determination sub-unit configured to determine the pose prediction result based on the local pose prediction result and the associated part pose data.

In a possible implementation, the reference pose data further comprises historical local pose data and a historical local pose change rate; and
the second determination sub-unit comprises:
a model prediction sub-unit configured to input the image feature and the reference pose data into the first pose determination model to obtain a predicted local pose change rate output by the first pose determination model; and
a fourth determination sub-unit configured to determine the local pose prediction result based on the predicted local pose change rate and the historical local pose data.

In a possible implementation, the reference pose data further comprises a historical local pose change acceleration; and
the model prediction sub-unit is specifically configured to: inputting the image feature and the reference pose data into the first pose determination model to obtain a predicted local pose change acceleration output by the first pose determination model; and determining the predicted local pose change rate based on the predicted local pose change acceleration and the historical local pose change rate.

In a possible implementation, the historical local pose data is used to describe a historical rotation state of the target part relative to the reference part.

In a possible implementation, the pose recognition model comprises a feature extraction module; and the second pose determination model comprises the feature extraction module and the trained first pose determination model.

In a possible implementation, the model construction apparatus 600 further comprises:
a model construction unit configured to train the pose recognition model by using the sample image and the pose data label corresponding to the sample image, where the pose recognition model is configured to perform global pose determination processing of the target part on input data of the pose recognition model.

Based on the relevant content of the above model construction apparatus 600, it can be seen that for the model construction apparatus 600 according to the embodiment of the present application, after obtaining a sample image, an image feature is first extracted from the sample image by using a pose recognition model that is pre-constructed, so that the image feature can better represent a pose of the target part (e.g., the wrist) in the sample image. Then, a first pose determination model is trained by using the image feature, reference pose data (e.g., pose data regarding the pose of a lower arm, the pose of the wrist in a preceding frame of image, the pose change situation of the wrist in the preceding frame of image, etc.) corresponding to the sample image, and a pose data label (i.e., a pose label) corresponding to the sample image, so as to enable the first pose determination model to learn how to perform local pose prediction processing based on the reference pose data during the training process, so that the trained first pose determination model can better predict the pose of the target part (particularly, the rotation state presented by the target part relative to the lower arm, etc.). Finally, a second pose determination model is determined by using the pose recognition model and the trained first pose determination model, so that the second pose determination model can better predict the pose of the target part in the image data based on the image data and the corresponding reference pose data, thereby allowing the second pose determination model to have a relatively good pose prediction function. Consequently, this enables the pose predicted by the model to be more accurate, which is conducive to improving the pose prediction effect. Because the above second pose determination model performs prediction processing of the pose of the target part in the image data based on the reference pose data corresponding to the image data, the pose predicted by the model is more accurate, which is conducive to improving the pose prediction effect.

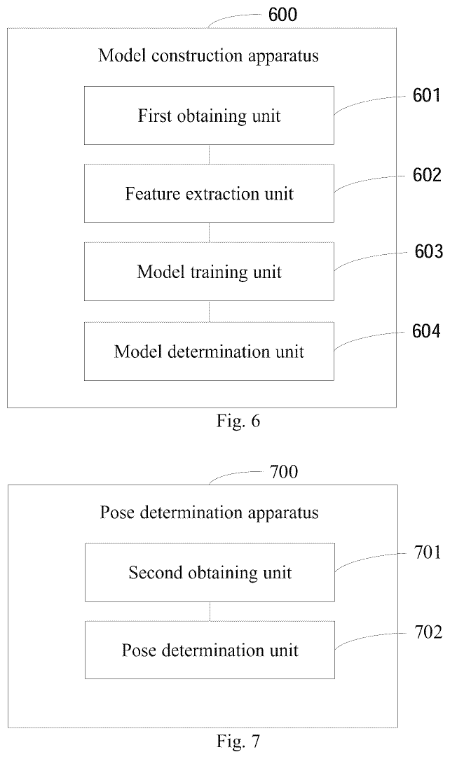

On the basis of the pose determination method according to the embodiments of the present application, an embodiment of the present application further provides a pose determination apparatus, which is explained and described below in conjunction with FIG. 7. FIG. 7 is a schematic diagram of a structure of a pose determination apparatus according to an embodiment of the present application. It should be noted that for technical details of the pose determination apparatus provided by the embodiment of the present application, reference can be made to the relevant content of the above pose determination method.

As shown in FIG. 7, the pose determination apparatus 700 according to this embodiment of the present application comprises:
a second obtaining unit 701 configured to obtain a to-be-processed image and reference pose data corresponding to the to-be-processed image, where the to-be-processed image is used to describe a target part of a second object; and
a pose determination unit 702 configured to determine pose representation data corresponding to the to-be-processed image based on a second pose determination model that is pre-constructed, the to-be-processed image, and the reference pose data corresponding to the to-be-processed image, where the second pose determination model is constructed by using any implementation of the model construction method according to the present application.

Based on the relevant content of the above pose determination apparatus 700, it can be seen that for the pose determination apparatus 700 according to the embodiment of the present application, after obtaining image data and reference pose data corresponding to the image data, the image data and the reference pose data corresponding to the image data can be processed by using a second pose determination model that is pre-constructed to determine pose representation data corresponding to the image data, so that the pose representation data can better represent a pose of the target part in the image data, thereby implementing a pose determination process for a certain part. Because the second pose determination model performs pose prediction processing on the pose of the target part in the image data based on the reference pose data, the pose representation data predicted by the model can more accurately represent the pose of the target part in the image data, which is conducive to improving the pose prediction effect.

Additionally, an embodiment of the present application further provides an electronic device. The device comprises a processor and a memory, where the memory is configured to store instructions or a computer program; and the processor is configured to execute the instructions or the computer program in the memory to cause the electronic device to execute any implementation of the model construction method or the pose determination method according to the embodiments of the present application.

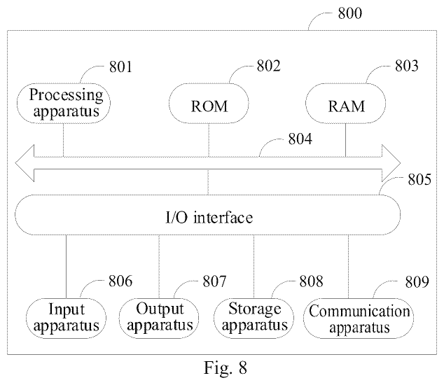

Reference is made to FIG. 8, which illustrates a schematic diagram of a structure of an electronic device 800 suitable for implementing the embodiments of the present disclosure. A terminal device in this embodiment of the present disclosure may comprise, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may comprise a processing apparatus (e.g., a central processing unit or a graphics processing unit) 801 that can execute a variety of appropriate actions and processing in accordance with a program stored in a read-only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are connected to one another through a bus 804. An input/output (I/O) interface 805 is also connected to the bus 804.

Generally, the following apparatuses may be connected to the I/O interface 805: an input apparatus 806 comprising, for example, a touchscreen, a touchpad, a keyboard, a mouse, a camera, a microphone, an accelerometer, and a gyroscope; an output apparatus 807 comprising, for example, a liquid crystal display (LCD), a speaker, and a vibrator; the storage apparatus 808 comprising, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure comprises a computer program product, which comprises a computer program carried on a non-transitory computer-readable medium, where the computer program comprises program code for executing the method shown in the flowchart. In such an embodiment, the computer program may be downloaded and installed from a network through the communication apparatus 809, installed from the storage apparatus 808, or installed from the ROM 802. When the computer program is executed by the processing apparatus 801, the above-mentioned functions defined in the method of the embodiment of the present disclosure are executed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present application further provides a computer-readable medium, where the computer-readable medium stores instructions or a computer program that, when run on a device, cause the device to execute any implementation of the model construction method or the pose determination method according to the embodiments of the present application.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may comprise a data signal propagated in a baseband or as a part of a carrier, the data signal carrying computer-readable program code. The propagated data signal may be in various forms, comprising but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, comprising but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network comprise a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, enable the electronic device to execute the above method.

Computer program code for executing operations of the present disclosure can be written in one or more programming languages or a combination thereof, where the programming languages comprise but are not limited to object-oriented programming languages, such as Java, Smalltalk, and C++, and further comprise conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, comprising a local area network (LAN) or a wide area network (WAN), or may be connected to an external computer (e.g., connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be executed at least partially by one or more hardware logic components. For example, without limitation, exemplary types of hardware logic components that may be used comprise: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present application, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, comprising any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that comprises a list of elements not only comprises those elements but also comprises other elements that are not expressly listed, or further comprises elements inherent to such process, method, article, or device. In the absence of more restrictions, an element defined by “comprising a . . . ” does not exclude another identical element in a process, method, article, or device that comprises the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present application. Various modifications to these embodiments are apparent to those skilled in the art, and the general principle defined herein may be practiced in other embodiments without departing from the spirit or scope of the present application. Therefore, the present application is not limited to the embodiments described herein but is to be accorded with the broadest scope consistent with the principle and novel features disclosed herein. At least one specification heading is required. Please delete this heading section if it is not applicable to your application. For more information regarding the headings of the specification, please see MPEP 608.01(a).

1. A method of model construction, comprising:
obtaining a sample image, a pose data label corresponding to the sample image, and reference pose data corresponding to the sample image, wherein the sample image is used to describe a target part of a first object, and the pose data label is used to describe an actual pose of the target part in the sample image;
extracting an image feature from the sample image by using a pose recognition model that is pre-constructed;
training a first pose determination model by using the image feature, the reference pose data, and the pose data label; and
determining a second pose determination model based on the pose recognition model and a trained first pose determination model.

2. The method according to claim 1, wherein the reference pose data comprises at least one of the group consisting of associated part pose data and historical reference data, the associated part pose data is used to describe an actual pose of a reference part associated with the target part in a to-be-used image, the reference part and the target part belong to the same object, the to-be-used image is used to describe at least two parts of the first object, the at least two parts comprises the target part and the reference part, the sample image is determined based on the to-be-used image, and the historical reference data is used to describe a historical state of the target part.

3. The method according to claim 2, wherein the historical reference data comprises at least one of the group consisting of historical pose data, a historical pose change rate, and a historical pose change acceleration.

4. The method according to claim 2, wherein the reference part is a parent node of the target part.

5. The method according to claim 1, wherein an obtaining process for the reference pose data comprises:
matching the pose data label with at least one data frame in a motion capture database, wherein the at least one data frame comprises pose data of several parts, the several parts comprising the target part; and
determining, in response to that there is a data frame in the motion capture database that matches the pose data label, the reference pose data corresponding to the sample image based on the data frame that is matched.

6. The method according to claim 1, wherein an obtaining process for the reference pose data comprises:
randomly selecting a data frame from a motion capture database, wherein the data frame comprises pose data of several parts, the several parts comprising the target part;
determining pose adjustment description information in response to that pose data of the target part in the data frame is different from the pose data label, wherein the pose adjustment description information refers to information required to adjust the pose data of the target part in the data frame to the pose data label; and
determining the reference pose data corresponding to the sample image based on the pose adjustment description information and the data frame.

7. The method according to claim 1, wherein a training process for the first pose determination model comprises:
determining a pose prediction result based on the first pose determination model, the image feature, and the reference pose data, wherein the pose prediction result is used to describe a predicted pose of the target part in the sample image; and
updating the first pose determination model based on the pose prediction result and the pose data label.

8. The method according to claim 7, wherein the reference pose data comprises associated part pose data, the associated part pose data being used to describe an actual pose of a reference part associated with the target part; and
the determining a pose prediction result based on the first pose determination model, the image feature, and the reference pose data comprises:
processing the image feature and the reference pose data by using the first pose determination model to obtain a local pose prediction result, wherein the local pose prediction result is used to describe a predicted rotation state of the target part relative to the reference part; and
determining the pose prediction result based on the local pose prediction result and the associated part pose data.

9. The method according to claim 8, wherein the reference pose data further comprises historical local pose data and a historical local pose change rate; and
the processing the image feature and the reference pose data by using the first pose determination model to obtain a local pose prediction result comprises:
inputting the image feature and the reference pose data into the first pose determination model to obtain a predicted local pose change rate output by the first pose determination model; and
determining the local pose prediction result based on the predicted local pose change rate and the historical local pose data.

10. The method according to claim 9, wherein the reference pose data further comprises a historical local pose change acceleration; and
the inputting the image feature and the reference pose data into the first pose determination model to obtain a predicted local pose change rate output by the first pose determination model comprises:
inputting the image feature and the reference pose data into the first pose determination model to obtain a predicted local pose change acceleration output by the first pose determination model; and
determining the predicted local pose change rate based on the predicted local pose change acceleration and the historical local pose change rate.

11. The method according to claim 9, wherein the historical local pose data is used to describe a historical rotation state of the target part relative to the reference part.

12. The method according to claim 1, wherein the pose recognition model comprises a feature extraction module; and
the second pose determination model comprises the feature extraction module and the trained first pose determination model.

13. The method according to claim 1, wherein before the extracting an image feature from the sample image by using a pose recognition model that is pre-constructed, the method further comprises:
training the pose recognition model by using the sample image and the pose data label corresponding to the sample image, wherein the pose recognition model is configured to perform global pose determination processing of the target part on input data of the pose recognition model.

14. A pose determination method, comprising:
obtaining a to-be-processed image and reference pose data corresponding to the to-be-processed image, wherein the to-be-processed image is used to describe a target part of a second object; and
determining pose representation data corresponding to the to-be-processed image based on a second pose determination model that is pre-constructed, the to-be-processed image, and the reference pose data corresponding to the to-be-processed image, wherein the second pose determination model is constructed by using a method of model construction, comprising:
obtaining a sample image, a pose data label corresponding to the sample image, and reference pose data corresponding to the sample image, wherein the sample image is used to describe a target part of a first object, and the pose data label is used to describe an actual pose of the target part in the sample image;
extracting an image feature from the sample image by using a pose recognition model that is pre-constructed;
training a first pose determination model by using the image feature, the reference pose data, and the pose data label; and
determining a second pose determination model based on the pose recognition model and a trained first pose determination model.

15-16. (canceled)

17. An electronic device, comprising: at least one processor and a memory, wherein
the memory is configured to store instructions or a computer program; and
the processor is configured to execute the instructions or the computer program stored in the memory to cause the electronic device to perform a method of model construction, comprising:
obtaining a sample image, a pose data label corresponding to the sample image, and reference pose data corresponding to the sample image, wherein the sample image is used to describe a target part of a first object, and the pose data label is used to describe an actual pose of the target part in the sample image;
extracting an image feature from the sample image by using a pose recognition model that is pre-constructed;
training a first pose determination model by using the image feature, the reference pose data, and the pose data label; and
determining a second pose determination model based on the pose recognition model and a trained first pose determination model.

18. (canceled)

19. The electronic device according to claim 17, wherein the reference pose data comprises at least one of the group consisting of associated part pose data and historical reference data, the associated part pose data is used to describe an actual pose of a reference part associated with the target part in a to-be-used image, the reference part and the target part belong to the same object, the to-be-used image is used to describe at least two parts of the first object, the at least two parts comprises the target part and the reference part, the sample image is determined based on the to-be-used image, and the historical reference data is used to describe a historical state of the target part.

20. The electronic device according to claim 19, wherein the historical reference data comprises at least one of the group consisting of historical pose data, a historical pose change rate, and a historical pose change acceleration, and
wherein the reference part is a parent node of the target part.

21. The electronic device according to claim 17, wherein an obtaining process for the reference pose data comprises:
matching the pose data label with at least one data frame in a motion capture database, wherein the data frame comprises pose data of several parts, the several parts comprising the target part; and
determining, in response to that there is a data frame in the motion capture database that matches the pose data label, the reference pose data corresponding to the sample image based on the data frame that is matched.

22. The electronic device according to claim 17, wherein an obtaining process for the reference pose data comprises:
randomly selecting a data frame from a motion capture database, wherein the data frame comprises pose data of several parts, the several parts comprising the target part;
determining pose adjustment description information in response to that pose data of the target part in the data frame is different from the pose data label, wherein the pose adjustment description information refers to information required to adjust the pose data of the target part in the data frame to the pose data label; and
determining the reference pose data corresponding to the sample image based on the pose adjustment description information and the data frame.

23. The electronic device according to claim 17, wherein a training process for the first pose determination model comprises:
determining a pose prediction result based on the first pose determination model, the image feature, and the reference pose data, wherein the pose prediction result is used to describe a predicted pose of the target part in the sample image; and
updating the first pose determination model based on the pose prediction result and the pose data label.
